(19) United States
(12) Patent Application Publication
(10) Pub. No.: US 2019/0180393 A1
(43) Pub. Date: Jun. 13, 2019

(54) PROPRIETOR SIDE AUTOMATED LISTING AND PRICING MANAGEMENT

(71) Applicant: Renty, Inc., Seattle, WA (US)

(72) Inventors: Edward Alexander Kelly, Seattle, WA (US); Michael Samuel Steuer, Los Angeles, CA (US)

(21) Appl. No.: 15/840,867

(22) Filed: Dec. 13, 2017

(51) Int. Cl. G06Q 50/16; G06Q 30/02; G06Q 30/06; G06Q 40/02; G06Q 30/08

(52) U.S. Cl. CPC G06Q 50/16; G06Q 30/0283; G06Q 30/08; G06Q 30/0645; G06Q 40/025; G06Q 30/0277

(57) ABSTRACT

Automated listing and pricing management of real estate property is disclosed. Specifically, systems and methods to efficiently list property and to providing listing information to customer via mobile applications are disclosed. To optimize the listing retrieval experience from the client perspective, renter qualifications are provided to a customer prior to a time investment in the bidding process. From the proprietor's perspective, dynamic pricing recommendations are generated to optimize profit and minimize vacancies. Tools are further disclosed to management multiple properties and to provide analytics reporting.

### BACKGROUND

Selling, leasing, renting and generally monetizing real estate property is increasingly competitive. Proprietors such as owners, landlords and property managers are responsible for monetizing multiple properties and balancing pricing against other considerations such as minimizing vacancies and suitability of renters. Certainly, proprietors are faced with a classic supply and demand dilemma—high rents may increase vacancies and low rents may yield low vacancies at the expense of maximizing profit. However, to competitively address this problem, proprietors are faced with complexities including managing large amounts of data about the real estate/rental markets, customers, regulations, and competitors to name a few.

Beyond data management is the acknowledgement that customer behavior to search for real estate/rentals continues to evolve. Increasingly, customers rely primarily if not solely on mobile devices for real estate/rental search. Present automation does not optimize the user experience for mobile device real estate/rental search.

Managing large amounts of data lends itself to automation. Presently, automation of the real estate process is primarily drawn on a per transaction basis from the perspective of the customer. In contrast, automation of the real estate process from the perspective of the proprietor is very limited. In particular, proprietor side property management generally relates to tracking and tallying of transactions, and do not holistically collect and process information beyond that of the property transactions itself. Accordingly, present automation does not systematically collect and process information to enable automated guidance to proprietors for managing listings and properties dynamically.

Accordingly, present automation does not provide a data management solution that goes beyond per transaction data tracking, such that the automation can dynamically and holistically manage the listing and property management process from a proprietor's perspective.

### BRIEF DESCRIPTION OF THE DRAWINGS

The Detailed Description is set forth with reference to the accompanying figures.

FIG. 1 is a top level context diagram for Automated Listing and Pricing Management.

FIG. 2 is a block diagram of an example architecture for Automated Listing and Pricing Management.

FIG. 3 is a block diagram for a listing management engine for Automated Listing and Pricing Management.

FIG. 4 is a flow chart for processing listings from the perspective of the client in the context of Automated Listing and Pricing Management.

FIG. 5 is a flow chart for processing listings from the perspective of the server in the context of Automated Listing and Pricing Management.

FIG. 6 is a flow chart for dynamic pricing in the context of Automated Listing and Pricing Management.

FIG. 7 is a flow chart for multiple property management in the context of Automated Listing and Pricing Management.

### DETAILED DESCRIPTION

### Context of Automated Listing and Pricing Management

Present day data management systems for real estate and rentals do not provide a systemic platform for managing data holistically sufficient to provide automated and dynamic guidance to proprietors. Guidance may include all aspects of the process such as property list generation, property search, screening, closing. Accordingly, a data management platform and a listing management engine and use cases collectively comprising automated listing and pricing management are described herein.

Use cases for data management may include managing pricing and managing bids for properties under management. One philosophy of property management is to enable a proprietor to have the data needed to make informed property decisions. Different proprietors may have different goals. One proprietor may wish to lower pendency on market. Another may seek to have the longest rental periods to lower renter churn. Yet another may seek to have the highest rents. Accordingly, data management can range from providing information and recommendations to proprietors to having a proprietor opt for automated pricing.

Similarly, bidding may be configured to maximize choice for a proprietor. A proprietor may initiate a marketing campaign to move a property unit. One way to maximize choice is to lower the friction of obtaining bids. A listing management system may generate internet links that are easily and immediately accessed. A mobile application may provide a quick and one stop portal to place a bid. Potentially bidders may immediately see what the target renter is. Customer prequalification information requests may be initiated concurrently. Bids may be collected. In short, the philosophy may be to make it as easy as possible for customers to submit bids and for a proprietor to make a choice of which bid, if any to accept.

This philosophy may extend to the prequalification process. In some embodiments, prequalification may be a precondition for receiving a bid. However, in other embodiments, where the philosophy is to maximize proprietor choice, the prequalification is performed independently, and a customer may still place a bid, even if is possible that the customer does not qualify. In this way, a proprietor may make a final decision as to which bid to accept. For example, a proprietor may make the decision to accept a high bid from a low credit rating bidder as opposed to a low bid from high credit rating bidder. The systems and processes for the above are described in greater detail below

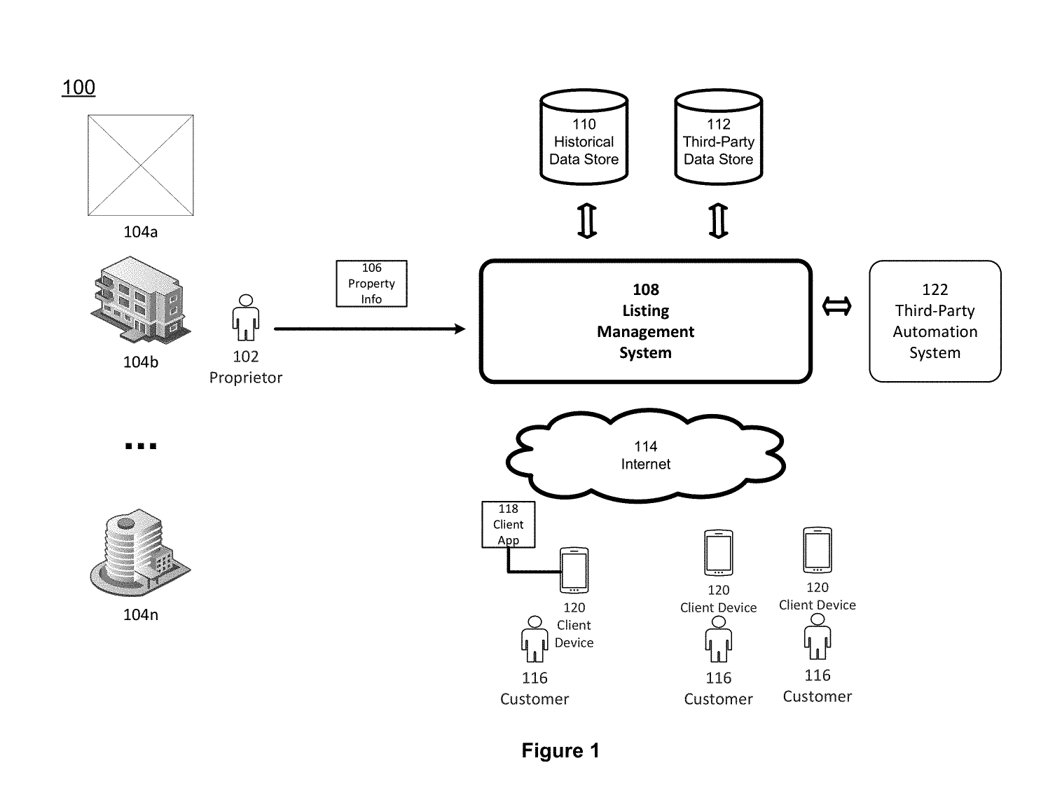

The context for automated listing and pricing management is illustrated per context diagram 100 in FIG. 1.

A proprietor 102 may own one or more real estate properties 104a-n. A proprietor 102 is an owner or a party responsible for monetizing and managing the properties 104a-n. Examples of proprietors are landlords, landlord agents and property managers. Monetizing properties 104a-n include selling or renting the properties for short or long term leases or alternatively for single event use.

Real estate properties 104a-n may include land, commercial buildings, residential dwellings, and event venues. In some cases, there may be features of the real estate, such as facilities machine shops, recreational amenities (beaches, pools), that may motivate purchase or rental. Features need not be facilities, but may be attributes of a property. For example, a potential residential purchaser may be seeking property featuring waterfront, view, or a property age of less than ten years.

To monetize real estate properties 104a-n, a proprietor 102 seeks to create dynamic listings and a user experience most likely to maximize profit. Accordingly, proprietor 102 may enter property information 106 into a listing management engine 108. Property information 106 includes a record of each property to be listed or otherwise monetized, including identity information of the property, features and/or attributes and fields in general of the property that are common search fields for property, and proprietor parameters that contain information about the proprietor's expectations and constraints around transactions for the property. Expectations and constraints may include pricing and vacancy parameters such as a proprietor's target price range and/or a proprietor's maximum time on market range.

The listing management engine 108 accesses a historical data store 110 which contains a history of transactions performed by the proprietor 102. A transaction record may include not only an identifier for the property, sale/rental price, vacancy history, and identifiers for agents who performed the transaction, but also data regarding pricing changes and events that motivated those pricing changes. The historical data store 110 may also import of transactions performed by other parties than the proprietor 102.

The listing management engine 108 is capable of accessing third-party data stores 112 to supplement and cross reference with the historical data store 110. The third-party data stores 112 may be additional information about the property such as data in the Multiple Listing Service (MLS). The third-party data stores 112 may also include event data that may impact pricing and time on market for a property such as crime report databases, and school rankings.

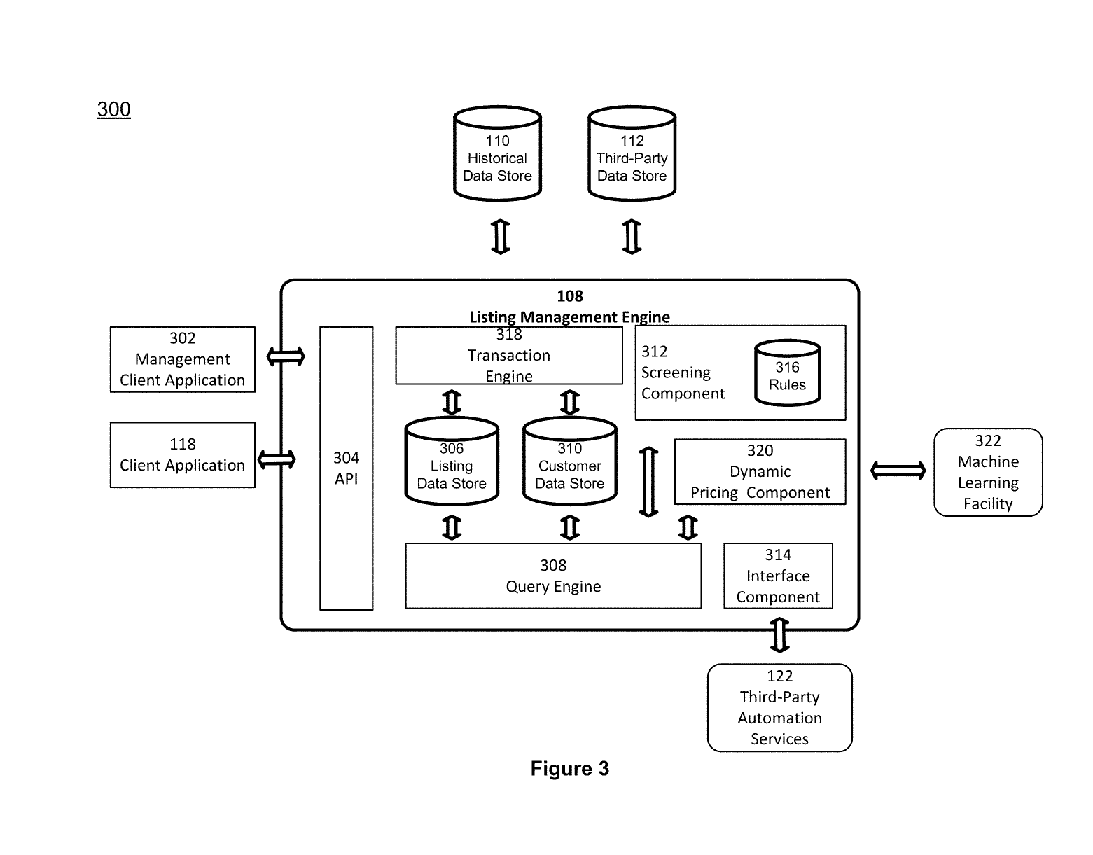

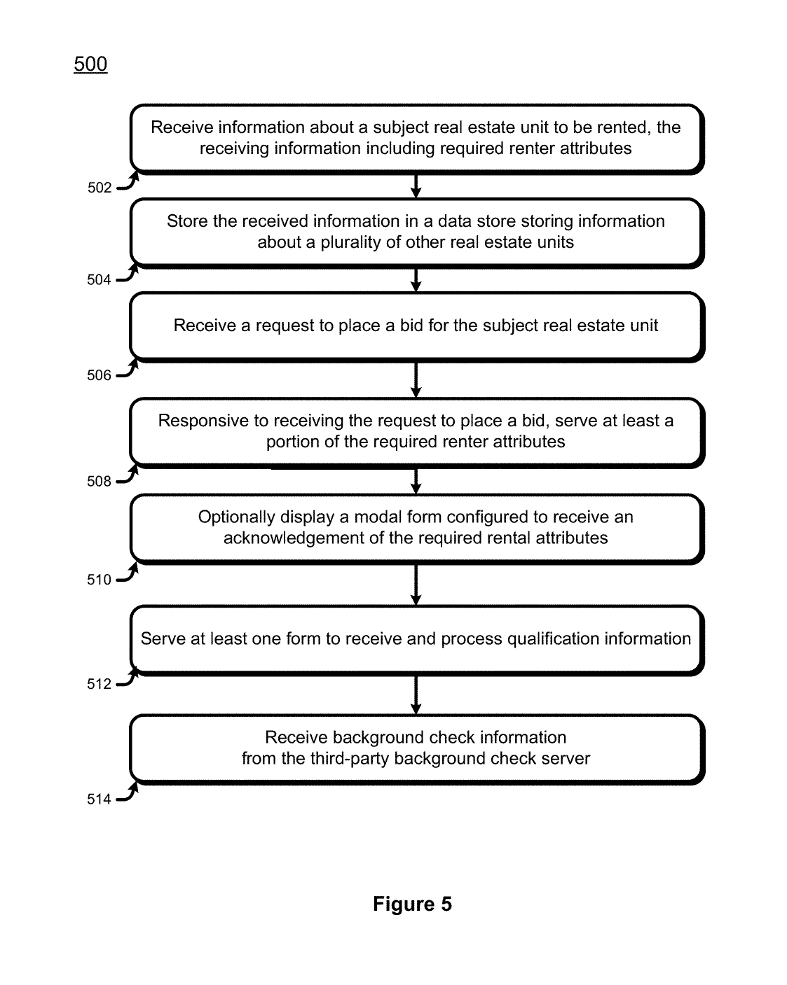

The listing management engine 108 is software executing on a computer where the software contains logic for collecting information, dynamically generating recommendations, such as pricing, interfacing with outside entities, and fulfilling transactions regarding the monetization of a property. The listing management engine 108 is described in further detail with respect to FIG. 3. Some embodiments of dynamic recommendations, in particular with respect to pricing, are described in further detail with respect to FIG. 5.

The listing management engine 108 is accessible via the internet 114. The listing management engine 108 may be accessible by a customer 116 via a client application 118 through a customer's device 120. A customer 116 is any party that may purchase/rent a listed property in the listing management engine 108. The mobile device 120 is generally a cellular smart phone and the client application 118 is generally a mobile application. In other embodiments, the listing management engine 108 may be accessed via the client application 118 comprised web application components via an internet browser running on a personal computer as the customer's device 120. Examples of web application components range without limitation from a simple HTML/HTML5 web page to applets and/or servlets.

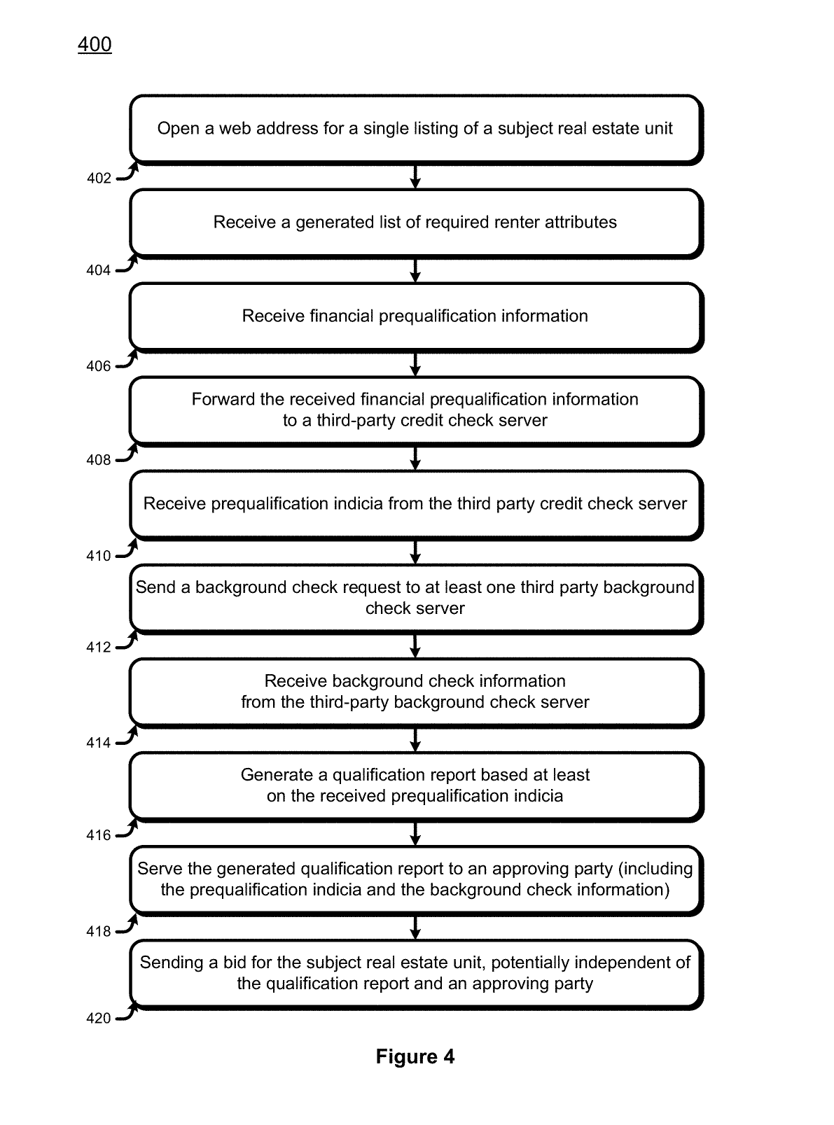

The client application 118 takes a customer 116 through the process of reviewing property and property rental information, customer screening, creating an offer for the property and related activities. This process is described in further detail with respect to FIG. 4 and FIG. 5.

Additionally, in the course of this process the client application may communicate with the listing management engine 108 which in turn may delegate and/or forward parts of the process to third-party automated services 122. Examples of third-party automated services 122 may include credit check and background check facilities. The third-party automated services 122 may operate independently of the listing management engine, and may be interacted with via an interaction module, potentially in the listing management engine 108, to ensure independent operation.

### Exemplary Architecture for Automated Listing and Pricing Management

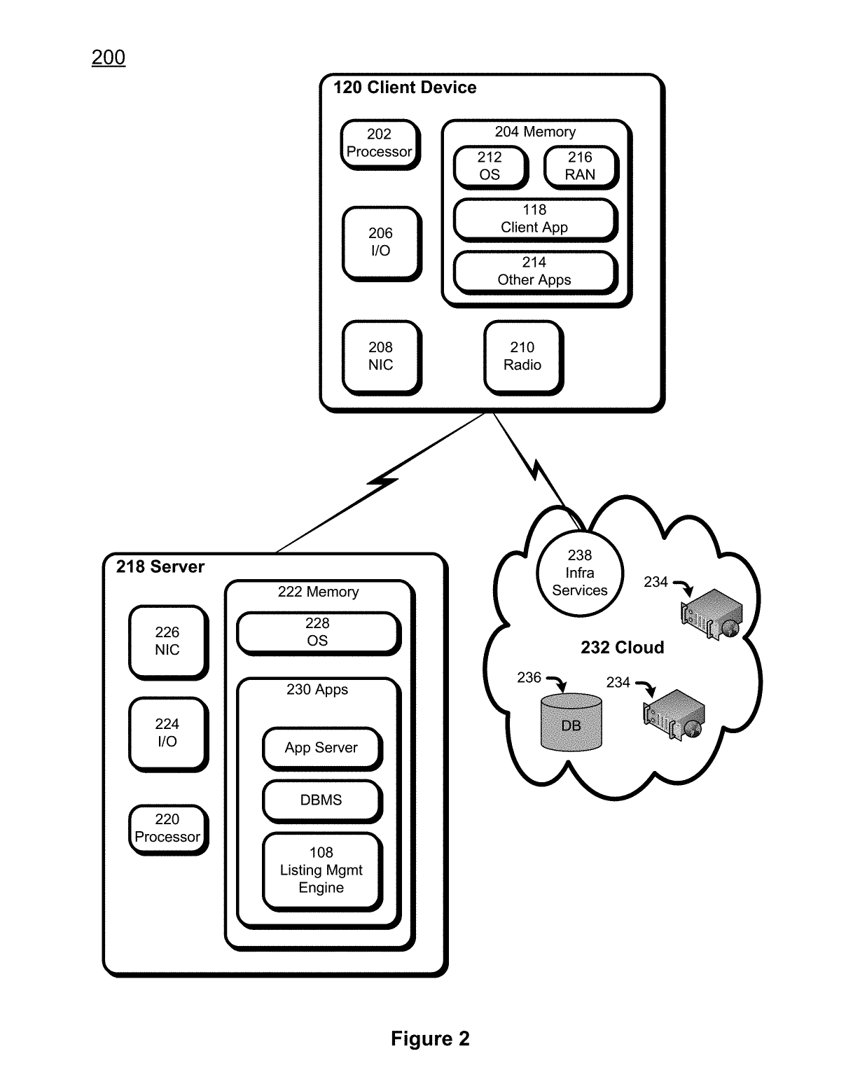

Automated listing and pricing management functionality is supported by a distributed computing platform architecture. The customer's device 120 runs a client application 118 that can connect to servers running the listing management engine 108 and the third-party automated services 122 via the internet or alternatively via a local area network. The internet may be accessible via a mobile connection such as a cellular network or alternatively may be accessed via a wired network. An exemplary architecture diagram 200 for the automated listing and pricing management functionality is shown in FIG. 2.

The client side application 118 is generally hosted on a computing device 120. Exemplary computing devices include without limitation smart phones, personal computers, laptops, embedded devices, and tablet computers. The computing devices 120 are networked.

The computing device 120 may have a processor 202, a memory 204. The processor may be a central processing unit, a repurposed graphical processing unit, and/or a dedicated controller such as a microcontroller. The computing device 120 may further include an input/output (I/O) interface 206, and/or a network interface 208. The I/O interface 206 may be any controller card, such as an universal asynchronous receiver/transmitter (UART) used in conjunction with a standard I/O interface protocol such as RS-232 and/or Universal Serial Bus (USB). The network interface 208, may potentially work in concert with the I/O interface 206 and may be a network interface card supporting Ethernet and/or Wi-Fi and/or any number of other physical and/or datalink protocols. The computing device 120 may participate in a cellular network. In this case, the computing device 120 may have a cellular radio 210 that may also work in concert with the I/O interface 206.

Memory 204 is any computer-readable media which may store several software components including an operating system 212 and software components such as the client application 118 as well as other applications 214. Where the computing device 120 participates in a cellular network, the memory 204 may also store radio access software 216.

In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The computing device 120 connects to one or more servers 218. A server 218 is any computing device that may participate in a network. The network may be, without limitation, a local area network (“LAN”), a virtual private network (“VPN”), a cellular network, or the Internet. A server 218 is a computer and has analogous hardware components. Specifically, a server 218 will include a processor 220, a memory 222, an input/output interface 224 and a network interface 226.

The server memory 222 stores operating system 228 and application software 230. Server side application software may include application servers (also known as web servers) and database management systems such as a relational database or alternatively a No-SQL database. The application server and/or database management system provide a software platform for server side applications such as the listing management engine 108 or alternatively third-party automated services 122.

Server side application software may run as a service on the cloud 232. In the cloud, a server is not a physical server 218, but rather is a virtual machine. In the latter case, the cloud 232 may be comprised of a plurality of disaggregated servers which provide virtual application server 234 functionality and virtual storage/database management system 236 functionality. The disaggregated servers are physical computer servers, which may have a processor, a memory, an I/O interface and/or a network interface as described with respect to server 218. While the features and variations of the processor, the memory, the I/O interface and the network interface are substantially similar to those described for server 218, there may be some variances where the disaggregated servers are optimized for throughput and/or for disaggregation.

Services 234 and 236, and application software running on those services, may be made accessible via an integrated cloud infrastructure 238. Cloud infrastructure 238 not only provides access to cloud services 234 and 236 but also to billing services and other monetization services. Cloud infrastructure 238 may provide additional service abstractions such as Platform as a Service (“PAAS”), Infrastructure as a Service (“IAAS”), and Software as a Service (“SAAS”).

### Exemplary Listing Management Engine

The listing management engine 108 embodies the majority of the server side functionality for automated listing and pricing management. FIG. 3 contains a block diagram 300 illustrating the functional components of an exemplary listing management engine 108.

A listing management engine 108 may be accessed by two kinds of client software. The first is by a proprietor 102 and/or the proprietor's agents 102 via a management client application 302. The second is by a customer 116 via a customer client application 118. Both access the listing management engine 108 via an application programming interface (API) layer 304.

Proprietors and their agents 102 enter property information 106 into the listing management engine 108 via the management client application 302 into listing database 306. Additionally, proprietors and their agents 102 may run reports on individual listings or alternatively on portions of their property portfolio by querying the listing database 306 and other data stores in the listing management engine 108. Transacted data entry and queries may be effected via a query engine 308. In some cases, the query engine is made available via a database management system 236.

Similarly, customers 116 interact with the listing management engine 108 via a client application 118. The customer 116 may register with the listing management engine 108 and store customer information into customer database 310. Customer information may include an account identifier, a customer identifier, customer preferences and under some circumstances, billing information. Customer information is to be stored securely and in compliance with applicable identity and privacy laws and regulations.

One interaction with the listing management engine 108 that a customer 116 may initiate is to provide a listing identifier and to query for a specific listing from the listing database 306. The listing may include information about the property including location and attributes and features of the property as well as pricing information. The listing may be also accompanied with renter qualification information. In this way, a customer 116 may review those qualifications before making a bid or otherwise investing time in reviewing and bidding on the property. Querying interactions such as retrieving listings and customer registration are also via the query engine 308.

As described above, a customer 116 has the opportunity to self-screen prior to otherwise investing time in the bidding process. However, a proprietor 102 will also screen customers 116 to determine a customer's suitability for a property. Screening is performed by a screening component 312. The screening component 312 may query third-party automated services 122 for customer credit and background information. Because third-party automated services 122 may have regulatory and contractual restrictions, the listing management engine 108 may access the third-party automated services 122 via an interface component 314. Upon receiving customer information from the third-party automated services 122, the screening component 312 may access a rules data store 316 which contains criteria by which the screening component 312 evaluates the suitability of a customer 116 for a listed property.

The customer 116 may initiate offers and/or bids for the listing via the client application 118. A listing transaction engine 318 captures bids from customers 116 and accepted bids from proprietors and proprietor's agents 102 via the client application 118 and management client application 302 respectively. Bids and accepted bids are stored in a historical data store 110. Bid information generally includes a property identifier, a date/time stamp of the bid, any contextual information around the bid, and whether the bid was accepted or not.

It is worth pointing out that in some embodiments, the prequalification process is completely independent of the bidding process. Specifically, the prequalification process is initiated on third-party systems. Accordingly, bids may be received regardless if the customer prequalifies. Indeed, the customer may affirmatively know that they have not qualified, and they will not necessarily be prevented from bidding on properties. In this way, the listing management system is less likely to run afoul of access to habitable housing laws and regulations. In general, this enables the proprietor to have the final decision as whether or not to accept a bid or not.

Alternatively, in other embodiments, it may be desirable for bids to be blocked in the event that a potential bidder does not prequalify. In such scenarios, any prenotifications will be provided to potential bidders in compliance with any applicable habitable housing laws and regulations.

During the process of providing a listing, the listing may include pricing information. The pricing information may be stored in the listing database 306 as part of the listing information. However, in some embodiments the price may be automatically generated via a dynamic pricing component 320. The dynamic pricing component 320 may make use of bid information in the historical data store 110 and third-party data stores 112 to determine whether to change the listing price. The dynamic pricing component 320 may make use of machine learning services 322 to identify pricing patterns, and to recommend a price most likely to effect a proprietor's goals. A proprietor's goals may include maximizing profit or minimizing vacancy.

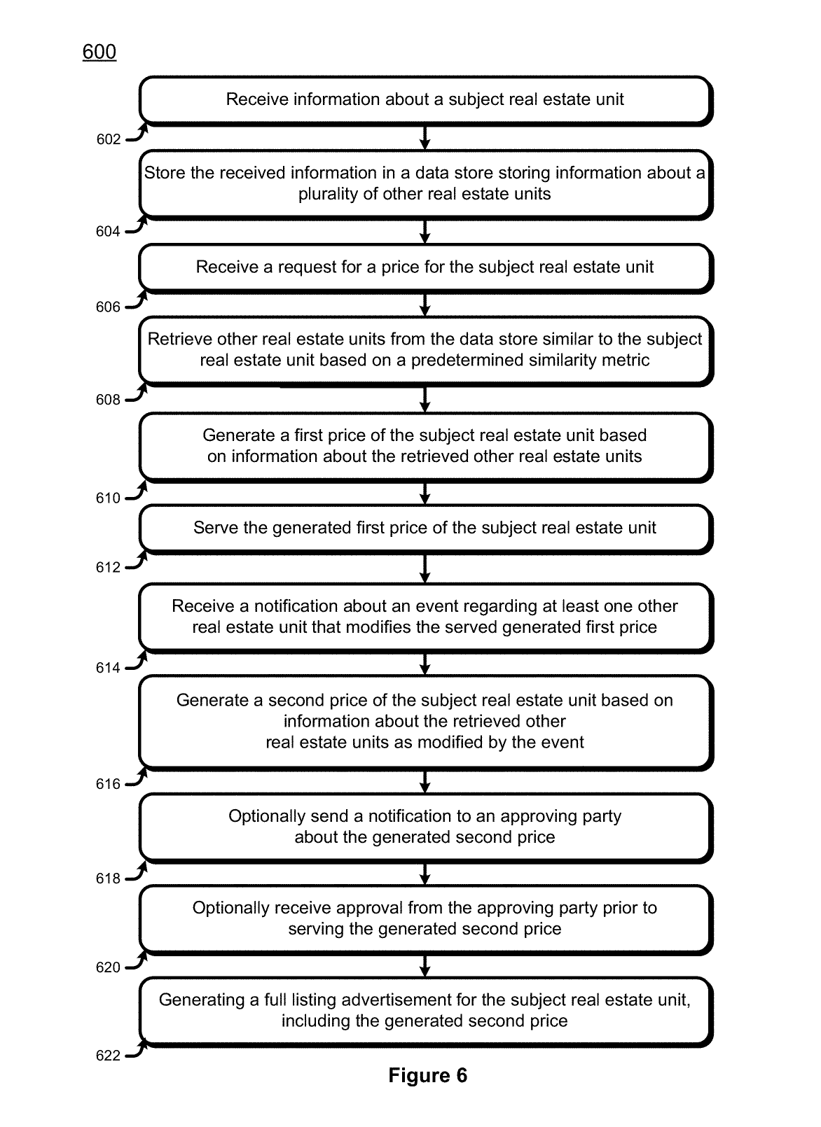

In other embodiments, a recommended price may be automatically generated, but sent to a proprietor. In this way, the proprietor may have the final decision as whether or not to accept a recommended price. In general, the dynamic pricing process is described in further detail with respect to FIG. 6.

### Exemplary Method for Listing Generation and Publication

Once the listing management engine 108 receives listing information 106 from a proprietor or proprietor's agent 102, the listing management engine 108 may publish listings. Similarly, customers 116 may register with the listing management engine 108, providing profile information about the customer and the customer's preferences.

Listings may be provided to customers 116 in the form of uniform resource locators (URLs) in text form or alternatively in bar code, QR code or other digitally coded representation that may be scanned. Since listings may be optimized for mobile devices, scanning a bar code or QR code provides an easier user experience than typing URL on a mobile device.

The automated listing and pricing management processes may be seen from the perspective of a customer 116 via the client application 118, or from the perspective of the server, including the listing management engine 108. FIG. 4 is a flow chart 400 of the interaction from the perspective of the client side. FIG. 5 is a flow chart 500 of the interaction from the perspective of the server side.

Turning to FIG. 4, in block 402, a customer 116 may open a web address, such as a URL for a single listing. A single listing is a listing of a single real estate offering, intended to be subject to a single real estate transaction. Specifically, a listing comprises all the elements of a real estate offering such as the buildings and rights of use where the offering is for a single sale or rental. For example, in the case of a rental, a listing may include the single dwelling space plus rights to the community pool and gym.

In block 404, prior to any qualification or bidding process, the customer 116 may receive a list of attributes a renter is to have to qualify for the listed property. The list may be automatically generated by the listing management engine 108. In this way, a customer 116 may self screen and stop reviewing the listing prior to any further commitment of time or expense.

If the customer 116 wishes to process, in block 406, the customer may initiate a financial prequalification process by entering financial prequalification information. The financial prequalification information may be limited to information sufficient to start a third-party automation service 122.

Note that there may be a plurality of prequalifications performed either serially or substantively concurrently. Example prequalifications include financial checks and criminal background checks. The latter is likely to occur where there are a plurality of third-party automation services 122.

Block 408 is a financial check. Specifically, in block 408, the listing management engine 108 starts a session with a third-party automation service 122 which independently collects financial information about the customer, and in block 410 performs a third-party credit check returning prequalification indicia of the customer 116 which may include whether the customer 116 qualified, and potentially additional information about the credit check itself. In general, prequalification indicia are a set of discrete credit criteria, where each criterion has an indicator of whether the customer satisfies that particular criterion.

The independent operation of the third-party automation service allows the listing management engine 108 to limit the information collected, as the collection of private information is delegated to the third-party automation service 122 which actually performs the credit check. This delegation is enforced by the interface component 314 of the listing management engine 108.

The payment of the credit check may be performed by the listing management engine 108, or alternatively may be collected by the third-party automation service 122. Where the former is performed, the listing management engine 108 may monetize the credit check by reserving a portion of the received payment.

Another prequalification check may be a criminal background check as in block 412 which may be performed serially with the financial check in block 410 in any order, or alternatively may be performed concurrently. Specifically, the listing management engine 108 may also perform a criminal background check on the customer 116. In block 412, using the customer identification information from the customer's registration, the listing management engine 108 may initiate a background check with a third-party automation service 122. In block 414, the results of the background check are returned by the third-party automation service 122 to the listing management service and from there to the customer 116 via the client application 118.

Upon collection of customer information, both from the customer's profile, as well as the third-party automation services 122, including the credit check and criminal background check, in block 416 the listing management engine generates a customer qualification report indicating whether the customer 116 qualifies for the listed property or not. In block 418, the generated report is sent to an approving party, usually the proprietor or proprietor's agent 102. The report may simply indicate whether the customer 116 qualified or alternatively may provide the individual prequalification indicia and results from the background check. Alternatively, if the customer 116 qualifies, approval may be automated.

In block 420 a customer 116 may submit an offer or bid via the client application 118. The offer or bid submission is potentially independent of the qualification report and/or approving party. As previously stated, it is not necessarily the case that prequalification is precondition for accepting a bid. Specifically, there may be accessibility to habitable housing regulations that prevent such a precondition. Similarly, a proprietor may wish to have the final condition as to which bids to accept. For example, a proprietor may wish to accept a higher bid from a lower credit bidder over that of a lower bid from a higher credit bidder. Choice of bids of the proprietor is maximized if bids are not affirmatively blocked via the prequalification process.

Turning to FIG. 5, flow chart 500 describes the process from the perspective from the server side. In block 502, the listing management engine 108 receives property information 106 from a proprietor or proprietor's agent 102. The property information 106 may also include renter qualifications comprised of attributes renter is to satisfy to qualify for the listed property. Accordingly, in block 504, the property information 106 is stored in the listing database 306, along with other listing records.

The listing management engine 108 may be used by the proprietor or proprietor's agents 102 to generate URLs and/or scannable digital codes as part of advertising the listing. Customer 116, invoke the URL and receive listing information via the client application 118 querying the listing database 306. The customer 116 executes the process as described with respect to FIG. 4. During the process, in block 508, the listing management engine 108 will generate a checklist of renter qualifications.

Some renter qualifications may be qualifications specified by the proprietor or proprietor's agent 102. However, some qualifications may be default values, provided by the listing management engine 108. Example renter attributes for qualification may be predetermined thresholds for credit rating, prior eviction history, criminal activity in the customer's background, and the customer's income/rent ratio.

Upon generation of the renter qualification list, in block 510, a modal form (a form that prevents returning to the client application 118 until the form is closed) optionally may be displayed to receive acknowledgement from a customer 116 that he or she has reviewed the qualifications. In some embodiments, the listing management engine 108 may store an indicator that the customer had reviewed the qualifications.

In block 512, upon receiving an acknowledgement from the customer 116, the listing management engine 108 can proceed to serve at least one form to start the qualification process as set forth with respect to FIG. 4.

If the customer 116 places a bid, the listing management engine 108 receives the placed bid and generates a record of the bid in the historical data store 110.

It is to be noted that the listing management engine 108 need not reject placed bids. A proprietor may initially specify required renter attributes only to learn that those attributes limited the number of available bids to an unacceptable level. Accordingly, a proprietor may have the ability to change required renter attributes.

Firstly a proprietor is the sole arbiter of the decision of whether or not to rent a property. Specifically, the proprietor may accept a bid even if the bid does not satisfy at least one required renter attribute. For example, in the case that a proprietor receives only one bid and the bid is not compliant with the renter attributes, the proprietor may send an override directive to the listing management engine 108, and accept the bid in order to receive some income rather than letting the property go unrented.

The proprietor does not make a decision in vacuum to accept a bid with at least one renter attribute satisified. Often the relaxation of one renter requirement is based on a change to another opposite or countervailing attribute. For example, a proprietor may accept a lower credit rating in favor of a larger deposit or alternatively higher rent. The relaxation of one attribute based on the strengthening of another attribute to bring a bid to acceptability is called a balancing, and the two attributes are said to be countervailing.

The willingness of the proprietor to change one or more required renter attributes shows the evolution of the mindset of the proprietor. In some cases, because a proprietor was willing to change at least one required renter attribute for one property, it may be desirable to change the corresponding at least one required renter attribute for other similar properties. Accordingly, the listing management engine 108 may select at least one other property stored in listing database 306, based on similarity, and may automatically update the required renter attributes associated with that at least one other property. In some embodiments, the proprietor may review the properties whose required renter attributes are updated, and further may change those properties manually. In other embodiments, the proprietor may select the properties to be updated, and bulk update the required renter attributes.

### Exemplary Method for Dynamic Pricing and Generation of Listings

The listing management engine 108 generates listings of real estate property. In addition to serving property information about listings, the listing management engine 108 generates URLs and scannable codes to initiate the customer screening and bidding process as set forth with respect to FIG. 4 and FIG. 5. FIG. 6 is a flow chart 600 for dynamic pricing and listing generation.

In block 602, the listing management engine 108 receives property information 106 from a proprietor or proprietor's agent 102 for a real estate unit. The property information 106 may include property identification information, property attributes, and optionally may include qualification information. For example, in the case of a rental property, financial qualification indicia such as income/rent ratio and credit scores may be specified. Where the property information 106 does not include qualification information, the listing management engine 108 may provide default qualifications. The received property information is stored in the listing database 306 in block 604. The proprietor or proprietor's agent 102 may disseminate URLs and scannable codes to access the listings via the client application 118. Specifically, a unique value is generated as associate with a listing. In this way when the listing management engine 108 receives this unique value, it retrieves the listing and serves it to the client application 118. The URL can embed the unique value or otherwise encode it. The URL itself may be converted to a bar code or QR code.

In block 606, when a listing is accessed via the client application 118, and the price for the listing is requested, the listing management engine 108 may simply serve a price for the listing that was stored with the listing. Alternatively, the listing management engine 108 via the dynamic pricing component 320 may serve an updated price. This eventuality is performed in block 608 where the dynamic pricing component 320 retrieves one or more comparative units. Specifically the dynamic pricing component 320 retrieves from the listing database 320, historical data store 110 and outside data stores 112 other real estate units that are similarly situated such that pricing for one of the units is indicative of pricing of the listing whose price is requested. In block 610, a price of the listed unit may be generated based on pricing patterns. In some embodiments, pricing patterns may be determined via machine learning 322.

Similarity may be determined via one or more similarity metrics. Example metrics include, type of dwelling, number of bedrooms in the unit, number of bathrooms in the unit, area of the unit, year the unit was built (or age of the unit), and location of the real estate unit.

Once the price is determined, in block 612, the generated price is served to the requestor.

At this point, different events may occur to motivate a price change for the listed unit. A similar unit may be sold. A similar unit may be repriced. Similar units may be added or delisted. The listing management engine 108 interfaces not only with its own listings via the listing database 306 and historical data store 110, but also with third-party data sources 112. In this way, the listing management engine 108 via the dynamic pricing component may monitor pricing and availability of other units.

In block 614, the listing management engine 108 receives a notification of such a change event, or otherwise detects the change event. Accordingly, the dynamic pricing component 320 may generate a new price for the listing unit in response to the change event. The new price may be generated similarly to blocks 608 and 610 where comparative units are selected an price generated from those comparative units.

Since proprietor or proprietor's agent 102 may desire to specifically approve any pricing changes, in block 618, the listing management engine 108 may optionally send a notification to the proprietor or proprietor's agent 102 of the generated repricing for the listed unit. The storing of the new price with the listing in the listing database 306 would occur in response to receiving approval from the approving agent, i.e. the proprietor or proprietor's agent 102.

Upon a repricing, the proprietor or proprietor's agent 102 may desire to automatically generate new listing information. The listing management engine 108 may generate a new URL and/or scanning codes as described above. Alternatively, the listing management engine 108 may generate a full listing where the property is illustrated, its attributes enumerated, along with the URL and/or scannable code in a document.

Over time, the proprietor or proprietor's agent 102 may desire to analyze the history and performance of their properties. As the original price and the new price of the listings are stored in the listing database 306 and/or the historical data store 110, the listing management engine 108 may generated reports on demand showing the original price and the repricing, and historical pricing data in general.

### Exemplary Method for Multiple Listing Management

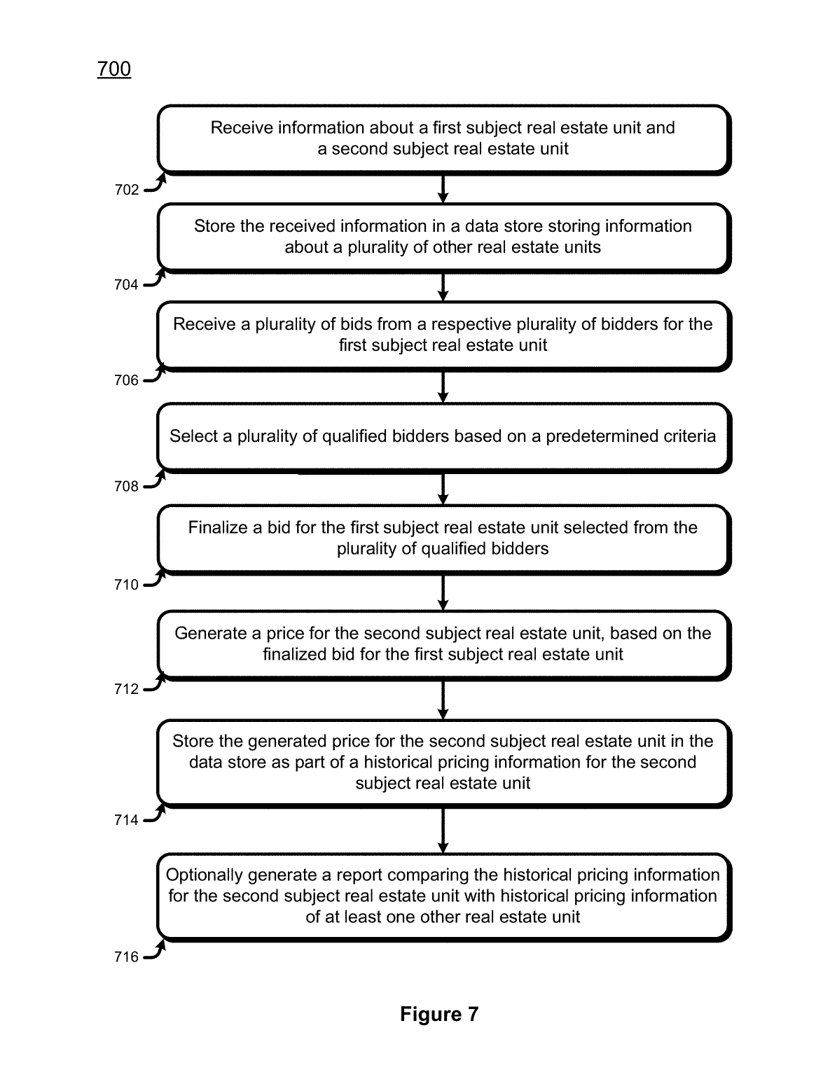

Up to this point, the discussion has been around data processing for a single listing. However, proprietors 102 may have not just a single listing, but a portfolio of properties to be managed. In some cases, there may be multiple units in the same building or complex. In other cases, there may be different real estate property locations. In this event, the proprietor 102 will be interested I managing multiple listings. FIG. 7 is a flow chart 700 of an analogue to the repricing process set forth in FIG. 6 specific to a multiple listing environment.

In block 702, the listing management engine 108 receives property information 106 from a proprietor or proprietor's agent for a first real estate unit and a second real estate unit. The two real estate units are to be similarly situated units, for example rental units in the same building. In general, the two units are to be similar enough such that pricing for one unit would be indicative of pricing for the other unit. In block 704, property information 106 for both units are stored in the listing database 306. Listing are disseminated as described with respect to FIG. 6.

In block 706, multiple customers 116 may make multiple bids, some on the first unit and some on the second unit, via the process set forth with respect to FIG. 4. In block 708, qualified customers 116 selected via the processes set forth with respect to FIG. 4 and FIG. 5. Specifically, customers 116 who satisfy the financial and criminal background checks are selected based on the prequalification indicia and other indicia.

In block 710, the proprietor or proprietor's agent 102 selects a bid from the selected qualifying bids. Alternatively, the listing management engine 108 may select from the qualifying bids via predetermined criteria. Example criteria include highest bid, earliest availability, or highest financial score or absence of criminal activity in the customer's background. The selected bid is stored by the listing management engine 108 in the historical data store 110.

As previously stated, the two units are similar such that pricing for the first unit is indicative of pricing of the second unit. Accordingly, in block 712, the dynamic pricing component 320 analyzes the set of qualifying bids and generates the probability that an amount for a bid for the second property would be received and the time window that the bid would be received. In this way, the dynamic pricing component 320 may balance vacancy against pricing amount. Based on proprietor preferences to maximize price versus minimizing vacancy, the dynamic pricing component 320 generates a price for the second unit. In block 714, the generated price is stored in the listing database 306 and a record kept in the historical database 110.

Later, in block 716, a proprietor 102 may use the listing management engine 108 to generate reports regarding the historical pricing information of either the first unit, the second unit, or both. The report may provide comparative information of the units or with respect to other units. The report may statistically aggregate pricing information, such as providing the average, minimum, maximum, and standard deviations for pricing and/or vacancy for groups of units. The report may provide a timeline showing when the dynamic pricing component 320 changed prices as well as the events that triggered the change in price. In some embodiments, the generated report may be a graphical report showing charts or other visuals as opposed to text.

In this way, a proprietor 102 may analyze pricing changes on his or her properties, as tracked and initiated by the listing management engine 108 and the dynamic pricing component 320. Specifically, as the listing management engine 108 may change recommended prices for properties, or changes to prices for properties change for other reasons, a proprietor may use such analytics to understand the drivers for property price changes.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method to generate real estate listing information, comprising:
receiving information about a subject real estate unit;
storing the received information in a data store storing information about a plurality of other real estate units;
receiving a request for a price for the subject real estate unit;
retrieving other real estate units from the data store similar to the subject real estate unit based on a predetermined similarity metric;
generating a first price of the subject real estate unit based on information about the retrieved other real estate units;
serving the generated first price of the subject real estate unit;
receiving a notification about an event regarding at least one other real estate unit that modifies the served generated first price;
generating a second price of the subject real estate unit based on information about the retrieved other real estate units as modified by the event; and
serving the generated second price.

2. The method of claim 1, wherein the subject real estate unit is a rental unit.

3. The method of claim 1, wherein the predetermined similarity metric is based at least on one of the following:
type of dwelling;
number of bedrooms of a real estate unit;
number of bathrooms of a real estate unit;
area of a real estate unit;
year a real estate unit was built; and
location of a real estate unit.

4. The method of claim 1, wherein the event behind the received notification is any one of the following:
sale of a real estate unit;
repricing of a real estate unit;
addition of a real estate unit; and
delisting of a real estate unit.

5. The method of claim 1, further comprising:
generating a full listing advertisement for the subject real estate unit, including the generated second price.

6. The method of claim 1, further comprising:
sending a notification to an approving party about the generated second price; and
receiving approval from the approving party prior to serving the generated second price.

7. The method of claim 1, further comprising:
generating a report showing the generated first price and the generated second price of the subject real estate unit; and
serving the generated report.

8. A method to generate real estate listing information, comprising:
receiving information about a subject real estate unit to be rented, the receiving information including required renter attributes;
storing the received information in a data store storing information about a plurality of other real estate units;
receiving a request to place a bid for the subject real estate unit;
responsive to receiving the request to place a bid, serving at least a portion of the required renter attributes; and
serving at least one form to receive and process qualification information.

9. The method of claim 8, wherein the served at least a portion of the required renter attributes is in the form of an automatically generated checklist.

10. The method of claim 9, wherein the automatically generated checklist includes additional attributes in addition to the required renter attributes explicitly stored in the data store.

11. The method of claim 11, wherein the additional attributes or the required renter attributes including at least one of the following:
credit rating;
prior eviction history;
criminal background; and
income/rent ratio.

12. The method of claim 8, further comprising:
displaying a modal form configured to receive an acknowledgement of the required rental attributes;
wherein the serving the at least one form to receive an process qualification information is response to receiving the acknowledgement of the required rental attributes.

13. The method of claim 8, wherein the served at least one form is a form in a mobile application.

14. A method to manage listings for multiple rental properties, comprising:
receiving information about a first subject real estate unit and a second subject real estate unit;
storing the received information in a data store storing information about a plurality of other real estate units;
receiving a plurality of bids from a respective plurality of bidders for the first subject real estate unit;
selecting a plurality of qualified bidders based on a predetermined criteria;
finalizing a bid for the first subject real estate unit selected from the plurality of qualified bidders;
generating a price for the second subject real estate unit, based on the finalized bid for the first subject real estate unit; and
storing the generated price for the second subject real estate unit in the data store as part of a historical pricing information for the second subject real estate unit.

15. The method of claim 14, wherein the data store stores information about a plurality of other real estate units, including historical pricing information for the respective other real estate units;
generating a report comparing the historical pricing information for the second subject real estate unit with historical pricing information of at least one other real estate unit.

16. The method of claim 14, wherein the historical pricing information of the at least one other real estate unit is a statistical operation on an aggregation of a plurality of other real estate units.

17. The method of claim 14, wherein the historical pricing information of the at least one other real estate unit includes information about events that caused a change in price of the other real estate unit.

18. The method of claim 17, wherein the events that caused a change in price of the other real estate unit, are shown on a graphical time line.

19. A method to qualify a potential renter of a subject real estate unit, comprising:
opening a web address for a single listing of a subject real estate unit;
receiving a generated list of required renter attributes;
receiving financial prequalification information;
forwarding the received financial prequalification information to a third-party credit check server;
receiving prequalification indicia from the third-party credit check server;
generating a qualification report based at least on the received prequalification indicia;
serving the generated qualification report to an approving party; and
sending a bid for the subject real estate unit.

20. The method of claim 19, further comprising:
sending a background check request to at least one third-party background check server;
receiving background check information from the third-party background check server; and
including at least a portion of the background check information in the served qualification report.

21. A method to dynamically adjust required renter attributes for a rental listing, the method comprising:
receiving information about a subject real estate unit to be rented, the receiving information including required renter attributes;
storing the received information in a data store storing information about a plurality of other real estate units;
receiving a request to place a bid for the subject real estate unit;
responsive to receiving the request to place a bid, serving at least a portion of the required renter attributes;
receiving a bid wherein at least one required renter attribute is not satisfied by the bid; and
receiving an override from a proprietor to accept the received bid permitting rental to a renter corresponding to the received bid.

22. The method of claim 21, wherein the override is based at least on receiving a directive to change at least one required renter attribute based on changing at least one other countervailing renter attribute.

23. The method of claim 22, further comprising, changing the at least one required renter attribute and at least one other countervailing renter attribute on at least one other real estate unit stored in the data store.
